(19) United States
(12) Patent Application Publication
(10) Pub. No.: US 2010/0175861 A1
(43) Pub. Date: Jul. 15, 2010

(54) LASER-WELDED HEAT EXCHANGER TUBE ASSEMBLY

(75) Inventors: Jiubo Ma, Shan Dong (CN); Zhishang Yang, Tiantai City (CN); Shizhu Zhao, Tiantai City (CN); Shoudu Zhang, Tiantai City (CN); Yuexuan Sheng, Tiantai City (CN); Lianmin Yang, Tiantai City (CN); Zengqiang Wang, Tiantai City (CN); Fuqiang Chen, Tiantai City (CN); Xinqiang Xu, Tiantai City (CN)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/731,534

(22) Filed: Mar. 25, 2010

(30) Foreign Application Priority Data
Sep. 29, 2007 (CN) 200710163053.5

(51) Int. Cl. F28F 1/00; B23K 26/00; F28F 9/02

(52) U.S. Cl. 165/173; 165/177; 219/121.64

(57) ABSTRACT

A tube assembly for a beat exchanger is provided having a first U-shaped stainless steel assembly component and a second U-shaped stainless steel assembly component. In addition, the tube assembly has at least one laser-welded joint coupling the first and second U-shaped assembly components together. The laser-welded joint has a weld that extends along substantially an entire length of the tube assembly.

### PRIORITY

This application claims the benefit of prior PCT application Serial Number PCT/CN08/72515 filed Sep. 25, 2008, which claims priority to Chinese Patent Application 200710163053.5 filed Sep. 29, 2007, which are incorporated herein by reference.

### TECHNICAL FIELD

The present disclosure relates to heat exchanger tube assemblies, and more particularly, to laser-welded stainless steel heat exchanger tube assemblies.

### BACKGROUND

Construction and earthmoving equipment, as well as many other types of machines, are commonly used in a wide variety of applications. Generally, such machines may be powered by an internal combustion engine. In order to optimize the performance of the machine, the engine should perform as efficiently as possible. Various methods have been developed to increase internal combustion engine efficiency. One method has been to incorporate a turbocharger into the internal combustion engine. The turbocharger may compress air prior to entering an engine intake or combustion chamber. Supplying the engine intake with compressed air (“charged air”) may allow for more complete combustion. This may result in lower emissions, improved performance, and better engine efficiency. However, compressing the air may also cause an increase in the intake air temperature. Supplying the engine intake with such heated charged air may lead to an undesirable increase in the amount of emissions exiting from the engine. Also, because engines may generally produce large quantities of heat already, adding heated charged air to the engine intake or combustion chamber may increase the operating temperature of the engine, thus resulting in excessive wear on engine components.

An air-to-air aftercooler (ATAAC) may be used to reduce smoke and other engine emissions by cooling the charged air before it enters the engine intake manifold. Using the ATAAC may also result in lower combustion temperatures, thus improving engine component life by reducing thermal stresses on the engine.

The ATAAC may include one or more lubes through which the heated charged air may pass. The outside of the tube may be subjected to some type of fluid, for example, ambient air, which may cool the tube. As the heated charged air passes through the tube, it may come into contact with the tube walls. Heat may be transferred from the charged air to the tube walls, and then from the rube walls into the ambient air, thus removing heat from the charged air. External fins may be added to the external surfaces of the tube walls to create greater surface area, which may provide improved heat transfer between the heated charged air and the ambient air.

In some traditional heat exchange systems, ATAAC components may be completely comprised of the same materials. One common material selection may include aluminum components having desired heat transfer properties. By way of example, these components may comprise tubings, fins, header assemblies, or manifolds. However, such aluminum components can be susceptible to corrosive effects within the operating environment. This can lead to shortened operational use of the ATAAC or require additional expense and/or downtime to service defective components of the ATAAC.

U.S. Pat. No. 5,730,213, issued to Kiser et al. (“Kiser”) discloses a heat exchanger having aluminum cooling tubes including a plurality of agitating dimples projecting into the interior surface of the tubes. The aluminum cooling tubes are sealed in a jointed connection at opposite tube ends to respective header plates. Aluminum fins are disposed between parallel aluminum cooling tubes to enhance heat transfer from the tubes.

Although the heat exchanger in the Kiser patent may cool heated gas, the heat exchanger design utilizes aluminum cooling tubes, which may be susceptible to the corrosive effects of gas flowing through the cooling tubes. In particular, corrosive elements in the gas flowing through the cooling tubes may erode the walls and joints of the cooling tubes leading to unwanted air leakage. Such leakage may adversely affect the cooling capacity and structural integrity of the heat exchanger. Furthermore, such leaks may adversely affect any other systems in fluid communication with the heat exchanger such as, for example, an exhaust gas recirculation system or an engine intake system.

The present disclosure is directed towards overcoming one or more of the problems set forth above.

### SUMMARY OF THE INVENTION

In one aspect, the present disclosure is directed toward a rube assembly for a heat exchanger. The tube assembly includes a first U-shaped stainless steel tube assembly component and a second U-shaped stainless steel tube assembly component. In addition, the tube assembly includes at least one laser-welded joint coupling the first and second U-shaped tube assembly components together. The at least one laser-welded joint includes a weld extending along substantially an entire length of the tube assembly.

Consistent with another aspect of the disclosure, a method is provided for producing a tube assembly for a heat exchanger. The method includes shaping a first assembly component into a U-shape and shaping a second assembly component into a U-shape. The method also includes combining the first and second assembly components so that at least a portion of the first assembly component is adjacent to at least a portion of the second assembly component. The method further includes securing the first and second assembly components together by focusing a laser along substantially an entire length of the adjacent portions of the first and second assembly components.

### BRIEF DESCRIPTION OF THE DRAWINGS

FIG. 1 provides a diagrammatic view of a heat exchanger according to an exemplary disclosed embodiment;

FIG. 2 provides a diagrammatic view of tubes and fins according to an exemplary disclosed embodiment;

FIG. 3 provides a diagrammatic view of a tube assembly according to an exemplary disclosed embodiment; and

FIG. 4 provides another diagrammatic view of a tube assembly according to an exemplary disclosed embodiment.

### DETAILED DESCRIPTION

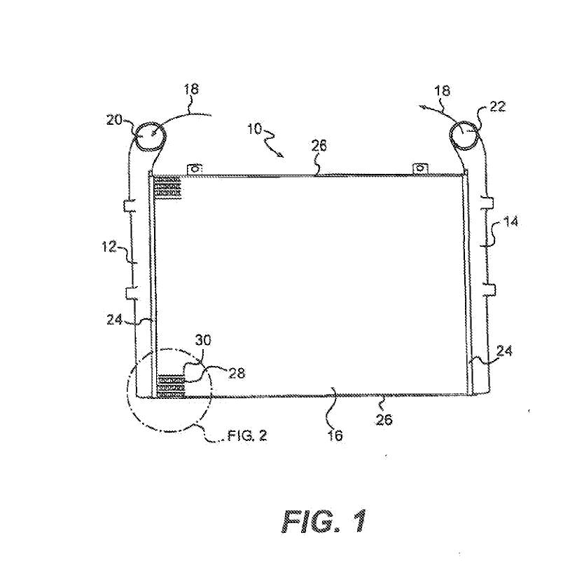

FIG. 1 illustrates an exemplary heat exchanger 10 for facilitating the transfer of thermal energy from a fluid to ambient air or a coolant fluid supplied by a coolant source (not shown). For the purposes of this disclosure, heat exchanger 10 is depicted and described as an air-to-air aftercooler (AATAC). However, one skilled in the art will recognize that heat exchanger 10 may be any other type of heat exchanger known in the art, such as, for example, a radiator, an exhaust gas recirculation cooler, or a hydraulic oil cooler. In addition, heat exchanger 10 may include an inlet manifold 12, an outlet manifold 14, and a core assembly 16.

Inlet manifold 12 and outlet manifold 14 may create a structural frame for heat exchanger 10 while providing a way for a fluid 18 to communicate with heat exchanger 10. It should be understood that fluid 18 may be any type of fluid known in the art such as, for example, air, exhaust gas, or hydraulic fluid. Inlet manifold 12 may include an inlet port 20, and outlet manifold 14 may include an outlet port 22. Fluid 18 may enter heat exchanger 10 through inlet port 20 and be directed into core assembly 16. After traversing core assembly 16 and undergoing a heat exchange operation, fluid 18 may be directed from core assembly 16 to outlet manifold 14 and exhausted through outlet port 22 of outlet manifold 14.

Core assembly 16 may facilitate the transfer heat from fluid 18 to a cooling medium (not shown). The cooling medium may be any type of cooling medium known in the art, such as, for example, air, water, glycol, or a water/glycol mixture. Core assembly 16 may include an assembly of headers 24, side sheets 26, external fins 28, and tube assemblies 30. Headers 24 may connect tube assemblies 30 to inlet and outlet manifolds 12 and 14. In addition, headers 24 and side sheets 26 may provide structural support for core assembly 16. Furthermore, headers 24 may include a design such as one including one piece or a single component. In another exemplary embodiment, headers 24 may include a design such as one made from modular components, which may be fitted together to form a unitary assembly.

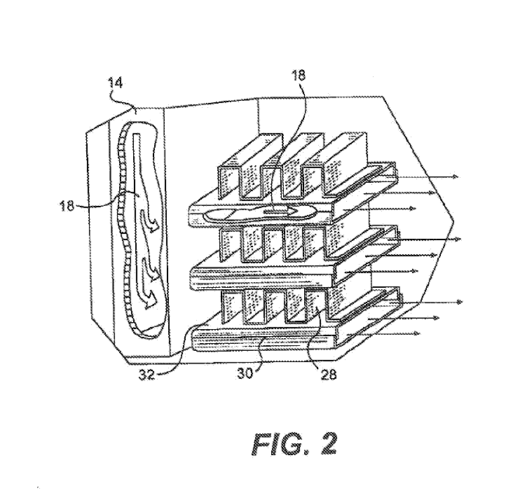

In one exemplary disclosed embodiment disclosed in FIG. 2, external fins 28 and tube assemblies 30 are shown enlarged. Tube assemblies 30 may be separated by external fins 28, which may be bonded to an exterior surface 32 of each tube assembly 30 to increase their external surface area thus aiding in heat transfer. External fins 28 may be formed from thin strips of metal, bent or otherwise formed into desired configurations. The configurations may allow for the free flow of ambient air across external fins 28, resulting in the ambient air removing heat from tube assemblies 30 and external fins 28. External fins 28 may have any number of different configurations, including, for example, serpentine, saw tooth, louver, and wave shapes. The embodiment shown in FIG. 2 depicts external fins 28 in a generally “U-shaped” pattern.

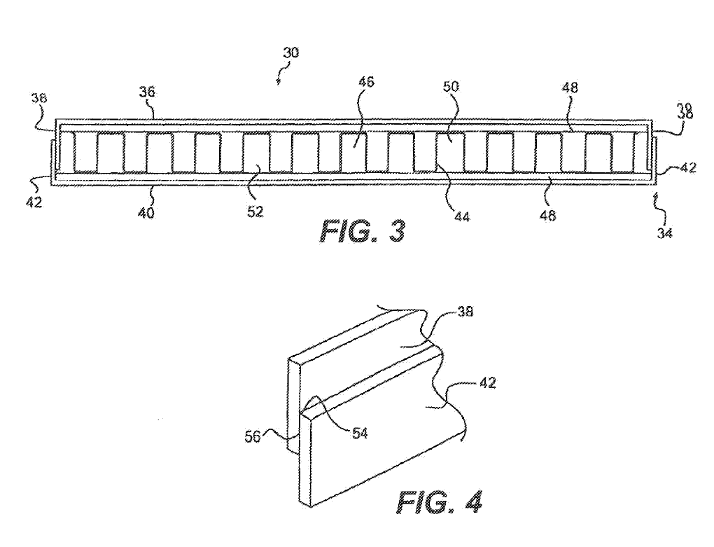

FIG. 3 illustrates an exemplary disclosed embodiment of components which form tube assemblies 30. Separate components may be joined together to form a unitary tube body 34 of tube assemblies 30. In some embodiments, the separate components may comprise a first U-channel 36, having connecting sides 38, and a second U-channel 40, having connecting sides 42. In addition, first U-channel 36 and second U-channel 40, may both be formed from unitary pieces of thin gauge stainless steel such as, for example, 304 or 304L grade stainless steel. The “U” shapes may be formed by a bending process or any other process known in the art capable of producing a “U” shape from a unitary piece of stainless steel. It should be understood that the stainless steel may resist possible corrosion from corrosive elements contained within fluid 18. Furthermore, thin gauge stainless steel may withstand the high temperatures sometimes experienced while fluid 18 flows through tubes 30. It contemplated that while two components, or U-channels, are shown in the exemplary disclosed embodiment of FIG. 3, two or more components may be utilized to form the unitary tube body 34 to generate tube assemblies 30, if desired.

Each tube assembly 30 may also include one or more devices such as, for example, turbulator 44 to promote mixing of fluid 18 passing through tube assembly 30. Creating a turbulent flow within tube assembly 30 may facilitate increased heat transfer between fluid 18, tube 30, and fins 28. Turbulator 44 may include relatively thin strips of metal material, bent or otherwise formed into desired configurations and located within an interior 46 of tube assembly 30. The metal material from which turbulator 44 is made may be any material such as, for example, stainless steel or any other material resistive to corrosive elements that may be contained within fluid 18 and capable of withstanding high temperatures that may be experienced while fluid 18 flows through tube assembly 30. Each tube assembly 30 may further include brazing layers 48 adjacent to the interior surfaces of first and second U-channels 36 and 40. Brazing layers may be conducive to forming rigid connections within tube assembly 30 as discussed below.

Tube body 34 may enclose turbulator 44 to create tube assembly 30. In one embodiment, second U-channel 40 may be fashioned slightly larger than first U-channel 36. A portion of turbulator 44 may be disposed within an interior receiving region 50 of first U-channel 36. Second U-channel 40 may fee positioned to encapsulate turbulator 44, for example, by disposing a portion of turbulator 44 and a portion of first U-channel 36 within an interior receiving region 52 of second U-channel 40.

Conventional welding techniques such as, for example, high frequency induction welding, extrusion, and arc or plasma welding may not be suitable for coupling thin gauge stainless steel components because such techniques may cause undesired distortions along the surfaces of the components. Such distortions may lead to undesired leakage. However, laser welding operations may cause minimal distortions in stainless steel surfaces and may be used to couple connecting surfaces 38 and 42 to facilitate the forming of tube assembly 30. It should be understood that the laser welding operation may be performed by any type of laser machine such as, for example, a pulsed YAG laser-welding machine or a carbon dioxide laser machine. In addition, connecting surfaces 38 and 42 may be secured to each other by any type of laser weld such as, for example, lap welds, stack welds, or any other type of weld capable of forming an air-tight seal between connecting surfaces 38 and 42.

When securing connecting surfaces 38 and 42 to each other, the laser from the laser welding machine may be focused on a seam edge 54 illustrated in FIG. 4. By focusing the laser on seam edge 54, portions of connecting surfaces 38 and 42 within the immediate vicinity of the laser may melt and combine with each other to form a lap weld. It should be understood that the laser maybe focused along substantially the entire length of connecting surfaces 38 and 42 to create a continuous weld and minimize or prevent any possible leaks.

In an alternate embodiment, the laser from the laser welding machine may be focused on a center seam portion 56. By focusing the laser on center seam portion 56, portions of connecting surfaces 38 and 42 within the immediate vicinity of the laser may melt and combine with each other to form a stack weld. It should be understood that the laser may be focused along substantially the entire length of connecting surfaces 38 and 42 to create a continuous weld and minimize or prevent any possible leaks.

Once first U-channel 36 and second U-channel 40 are secured to each other by a laser weld, a brazing operation may be implemented to rigidly retain turbulator 44 within first U-channel 36 and second U-channel 40. For example, brazing may occur along a surface of turbulator 44, brazing layers 48, an abutting surface of first U-channel 36, and second U-channel 40. It is contemplated that after the laser welding operation is performed, tube assembly 30 may be assembled in core 16 with other components such as headers 24, side sheets 26, and external fins 28. Core 16 may then be placed in a brazing furnace where many brazing joints may be created including, for example, a brazing joint between turbulator 44 and first and second U-channels 36 and 40. It is further contemplated that tube assembly 30 may be assembled without turbulator 44, if desired.

### INDUSTRIAL APPLICABILITY

The disclosed heat exchanger tube may resist corrosion issues that may result from corrosive elements contained within the air or gas flowing through the rube. The stainless steel material from which the tube may be manufactured may be resistant to corrosion. Also, the stainless steel material may withstand the high temperatures that may be experienced as hot gas flows through the tube.

By securing the thin gauge stainless steel assembly together by a laser welding process, possible leaks caused by corrosion and/or poor joint construction may be minimized or eliminated. The stainless steel material may effectively resist corrosion due to elements contained within the gas flowing through the tube. In addition, utilizing a laser welding process to secure the thin-gauge stainless steel components together may minimize distortion or structural degradation of the components. Such distortions or structural degradations may contribute to the formation of leaks within the tubes.

It will be apparent to those skilled in the art that various modifications and variations can be made in the disclosed apparatus without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A tube assembly for a heat exchanger, comprising:
a first U-shaped stainless steel tube assembly component;
a second U-shaped stainless steel tube assembly component; and
at least one laser-welded joint coupling the first and second U-shaped tube assembly components together, wherein the at least one laser-welded joint includes a weld extending along substantially an entire length of the tube assembly.

2. The tube assembly of claim 1, wherein the second U-shaped stainless steel tube assembly component is larger than the first U-shaped stainless steel tube assembly component so that at least a portion of the first U-shaped stainless steel tube assembly component may fit within the second U-shaped stainless steel tube assembly component.

3. The tube assembly of claim 2, wherein at least a portion of a surface of the second U-shaped stainless steel tube assembly component overlaps at least a portion of a surface of the first U-shaped stainless steel tube assembly component.

4. The tube assembly of claim 3, wherein the weld runs along an edge of the surface of the second U-shaped stainless steel tube assembly component overlapping at least a portion of a surface of the first U-shaped stainless steel tube assembly component.

5. The tube assembly of claim 3, wherein the weld runs along a central portion of the surface of the second U-shaped stainless steel tube assembly component overlapping at least a portion of a surface of the first U-shaped stainless steel tube assembly component.

6. A method of producing a tube assembly for a heat exchanger, comprising:
shaping a first assembly component into a U-shape;
shaping a second assembly component into a U-shape;
combining the first and second assembly components so that at least a portion of the first assembly component is adjacent to at least a portion of the second assembly component; and
securing the first and second assembly components together by focusing a laser along substantially an entire length of the adjacent portions of the first and second assembly components.

7. The method of claim 6, wherein combining the first and second assembly components includes causing at least a portion of the second assembly component to overlap at least a portion of the first assembly component.

8. The method of claim 7, further including focusing the laser along an edge of the portion of the second assembly component overlapping the first assembly component.

9. The method of claim 7, further including focusing the laser along a center region of the portion of the second assembly component overlapping the first assembly component.

10. A heat exchanger, comprising:
an inlet manifold;
an outlet manifold; and a core assembly including:
a header;
side sheets;
external fins; and
a tube assembly comprising:
a first U-shaped stainless steel tube assembly component;
a second U-shaped stainless steel tube assembly component; and
at least one laser-welded joint coupling the first and second U-shaped tube assembly components together, wherein the at least one laser-welded joint includes a weld extending along substantially an entire length of the tube assembly.

11. The heat exchanger of claim 10, wherein the second U-shaped stainless steel tube assembly component is larger than the first U-shaped stainless steel tube assembly component so that at least a portion of the first U-shaped stainless steel tube assembly component may fit within the second U-shaped stainless steel tube assembly component.

12. The heat exchanger of claim 11, wherein at least a portion of a surface of the second U-shaped stainless steel tube assembly component overlaps at least a portion of a surface of the first U-shaped stainless steel tube assembly component.

13. The heat exchanger of claim 12, wherein the weld runs along an edge of the surface of the second U-shaped stainless steel tube assembly component overlapping at least a portion of a surface of the first U-shaped stainless steel tube assembly component.

14. The heat exchanger of claim 12, wherein the weld runs along a central portion of the surface of the second U-shaped stainless steel tube assembly component overlapping at least a portion of a surface of the first U-shaped stainless steel tube assembly component.
